(19) United States
(12) Patent Application Publication
(10) Pub. No.: US 2016/0160511 A1
(43) Pub. Date: Jun. 9, 2016

(54) PANEL MOVING SYSTEMS

(71) Applicant: BLOX, LLC, Birmingham, AL (US)

(72) Inventor: Chris Giattina, Birmingham, AL (US)

(21) Appl. No.: 14/563,499

(22) Filed: Dec. 8, 2014

(51) Int. Cl. E04F 21/18; E04B 2/00; F16M 11/42; F16M 11/18; F16M 11/26

(52) U.S. Cl. CPC E04F 21/18; F16M 11/18; F16M 11/26; F16M 11/42; E04B 2/00

(57) ABSTRACT

The present disclosure generally pertains to a system for lifting and positioning wall panels. In certain embodiments, a lifting apparatus is provided, wherein a frame is configured to attach to opposing edges of a wall panel and wherein the frame, along with an attached wall panel, may be lifted and moved using a forklift. The width of the lifting apparatus may be adjusted to attach to wall panels of various widths. In other embodiments, a positioning apparatus is provided, wherein a frame is configured to roll across a surface and to attach to opposing edges of a wall panel. In certain embodiments, the positioning apparatus is configured to raise and lower using a source of force.

### RELATED ART

Efforts to reduce the cost of construction have led to the increased use of prefabricated building components. Prefabrication of such components reduces construction costs and waste while also increasing efficiency. Large, prefabricated wall panels, for example, are one such prefabricated building component and are commonly used in the construction of buildings. Such wall panels, however, are typically heavy and cumbersome. Despite their prevalent use, the current means of lifting and moving these wall panels, such as with large, specialized cranes, remains inefficient, expensive, and risks damage to the wall panels and surrounding structure. Further, space and budget constraints at construction locations often preclude the use of such large, specialized equipment. Therefore, a system capable of lifting and moving wall panels efficiently, inexpensively, and without a high risk of damage to the wall panels or other structures is generally desirable.

### BRIEF DESCRIPTION OF THE DRAWINGS

The present disclosure can be better understood with reference to the following drawings. The elements of the drawings are not necessarily to scale relative to each other, emphasis instead being placed upon clearly illustrating the principles of the disclosure. Furthermore, like reference numerals designate corresponding parts throughout the several views.

FIG. 1 depicts an exemplary embodiment of a pre-fabricated wall panel.

FIG. 2 depicts an exemplary embodiment of a lifting apparatus.

FIG. 3 depicts an exemplary embodiment of a positioning apparatus.

FIG. 4 depicts a partial cross-sectional view of an alternative embodiment of a positioning apparatus.

FIG. 5 is a diagram illustrating an exemplary positioning apparatus attached to each side of a wall panel.

FIG. 6 is a diagram illustrating an isometric view of an exemplary lifting apparatus attached to a forklift and a wall panel.

### DETAILED DESCRIPTION

The present disclosure generally pertains to a system for lifting and positioning wall panels. In certain embodiments, a lifting apparatus is provided, wherein a frame is configured to attach to opposing edges of a wall panel and wherein the frame, along with an attached wall panel, may be lifted and moved using a forklift. The width of the lifting apparatus may be adjusted to attach to wall panels of various widths. In other embodiments, a positioning apparatus is provided, wherein a frame is configured to roll across a surface and to attach to opposing edges of a wall panel. In certain embodiments, the positioning apparatus is configured to raise and lower using a source of force.

The use of any and all examples, or exemplary language (“e.g.,” “such as,” or the like) provided herein, is intended merely to better illuminate the embodiments and does not pose a limitation on the scope of the embodiments.

As used herein, “alloy” means pure metals and metals including incidental impurities and/or purposeful additions of metals and/or non-metals. For example, alloy may mean aluminum. Other examples of alloys include brass, bronze, copper, duralumin, Inconel, nickel, steel, titanium, other alloys known to those skilled in the art, and combinations of the same.

As used herein, “beam” means beams of different shapes including, but not limited to, rectangular and cylindrical beams.

As used herein, “bracket” means an anchored fixture capable of supporting a load.

As used herein, “composite” means engineered materials made from two more constituent materials. Examples of composites include, but are not limited to, carbon composites, in which carbon fiber is embedded in a matrix or resin, including epoxy matrices, thermosetting or thermoplastic resins, as well as composites containing fiberglass, ceramics, and other elements.

As used herein, “jack” means a device configured to support or lift a load through the application of force, including, but not limited to, mechanical jacks, such as screw jacks and scissor jacks, hydraulic jacks, such as floor jacks, bottle jacks, and barrel jacks, pneumatic jacks, strand jacks, and farm jacks.

As used herein, “tube” means tubes of different shapes including, but not limited to, rectangular and circular tubes.

As used herein, “wall panel” means a combination of one or more layers of various materials, having a front face and a rear face, for use in construction. In certain embodiments, two or more layers may be separated by a void. Examples of panels include, but are not limited to, sheets of drywall, metal, and other prefabricated walls and wall sections known in the art.

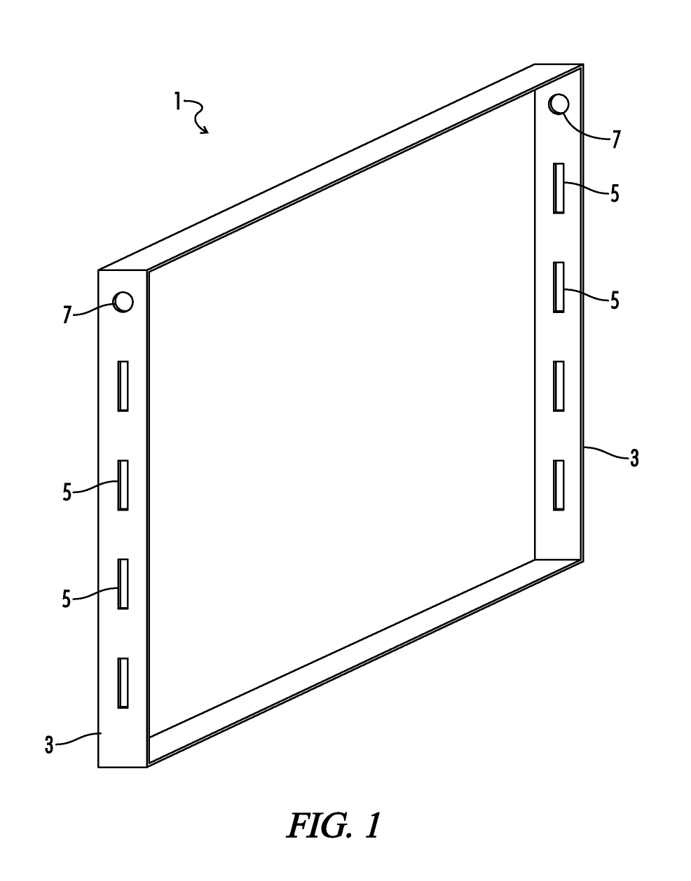

FIG. 1 depicts an exemplary embodiment of a wall panel 1. The lateral edges 3 of the wall panel 1 each contain at least one positioning aperture 5 and at least one lifting aperture 7. In certain embodiments, the positioning apertures 5 and the lifting apertures 7 are configured to accept the inserting of pins, bolts, clamps, and the like. In certain embodiments, the positioning apertures 5 and the lifting apertures 7 are incrementally spaced at uniform distances. For example, the positioning apertures 5 may be incrementally spaced 10 cm apart. In certain embodiments, the wall panel 1 includes multiple positioning apertures 5 and multiple lifting apertures 7 on each lateral edge 3. In certain embodiments, the positioning apertures 5 and the lifting apertures 7 are aligned vertically. In certain embodiments, the lateral edges 3 of the wall panel 1 are composed of an alloy.

The positioning apertures 5 and the lifting apertures 7 may be uniformly or differentially spaced at a range of distances. For example, in certain embodiments, the apertures are spaced approximately 100 cm apart. In certain embodiments, at least the first aperture proximal to the top of the lateral edge 3 is a lifting aperture 7. The positioning apertures 5 and the lifting apertures 7 may be configured at a range of widths and heights.

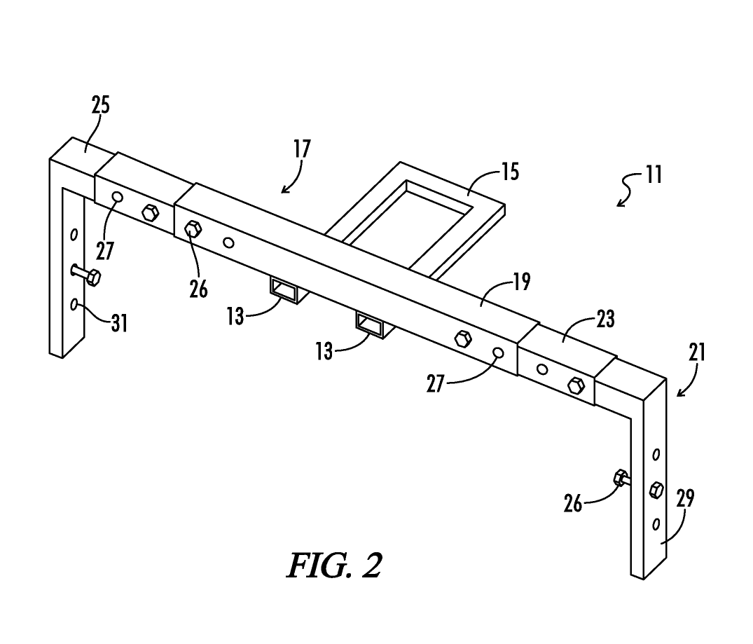

FIG. 2 depicts an exemplary embodiment of a lifting apparatus 11. The lifting apparatus 11 includes a two parallel tang receptacles 13, each a tube, connected by a crossmember 15. In certain embodiments, the crossmember 15 is a tube. In other embodiments, the crossmember 15 is a solid beam. The tang receptacles 13 are configured to accommodate forklift tangs to facilitate holding, raising, lowering, and moving of the lifting apparatus 11 by a forklift or equivalent machine having forklift tangs. The inner periphery of each tang receptacle 13 is configured to allow a close fit with an inserted forklift tang to minimize movement of the lifting apparatus 11 during operation of the forklift. In certain embodiments, the tang receptacles 13 are configured to cover the majority of the length of a forklift's tangs for increased stability. The tang receptacles 13 are connected centrally to the underside of, and are aligned perpendicularly to, a telescoping crossmember 17 such that the telescoping crossmember's 17 center of mass is located at the midpoint between the tang receptacles 13.

The telescoping crossmember 17 includes a central support bar 19 and two L-shaped lifting arms 21 on opposing sides of the central support bar 19. In certain embodiments, the central support bar 19 and L-shaped lifting arms 21 are tubes. In certain embodiments, the telescoping crossmember 17 further includes at least one secondary support bar 23 between the central support bar 19 and each L-shaped lifting arm 21. In certain embodiments, the secondary support bars 23 are tubes. Each secondary support bar 23 is configured to fit within the inner periphery of the central support bar 19. The horizontal arm 25 of each L-shaped lifting arm 21 is configured to fit within the inner periphery of the secondary support bar 23 and the central support bar 19. The central support bar 19, secondary support bar 23, and the horizontal arm 25 of each L-shaped lifting arm 21 may be secured to one another by one or more locking pins 26—although bolts, clamps, and like locking mechanisms are possible in other embodiments—inserted through telescope apertures 27 located on opposing faces of each of the foregoing to prevent the central support bar 19, secondary support bar 23, and the L-shaped lifting arm 21 from becoming dislodged from one another. The width of the telescoping crossmember 17 may be adjusted by sliding the secondary support bars 23 and/or the L-shaped lifting arms 21 and securing the same by inserting one or more locking pins 26 through incrementally-spaced telescope apertures 27 located on each of the foregoing.

Each L-shaped lifting arm 21 is further configured to include a vertical arm 29, perpendicular to the horizontal arm 25. The vertical arm 29 includes at least one arm aperture 31 located on opposing faces and configured to accept the inserting of pins, bolts, clamps, and the like. In certain embodiments, the L-shaped lifting arms 21 further include at least one secondary arm bar (not shown). In certain embodiments, the secondary arm bars are tubes. Each secondary arm bar is configured to fit within the inner periphery of the vertical arm 29. The vertical arm 29 and the secondary arm bar may be secured to one another by one or more locking pins 26 inserted through arm apertures 31 located on opposing faces of each of the foregoing. The combined length of the vertical arm 29 and secondary arm bar may be adjusted by sliding the secondary arm bar and securing the same by inserting one or more locking pins 26 through incrementally-spaced arm apertures 31 located on each of the foregoing.

In certain embodiments, the lifting apparatus 11 is composed of an alloy. In other embodiments, the lifting apparatus 11 is composed of a composite.

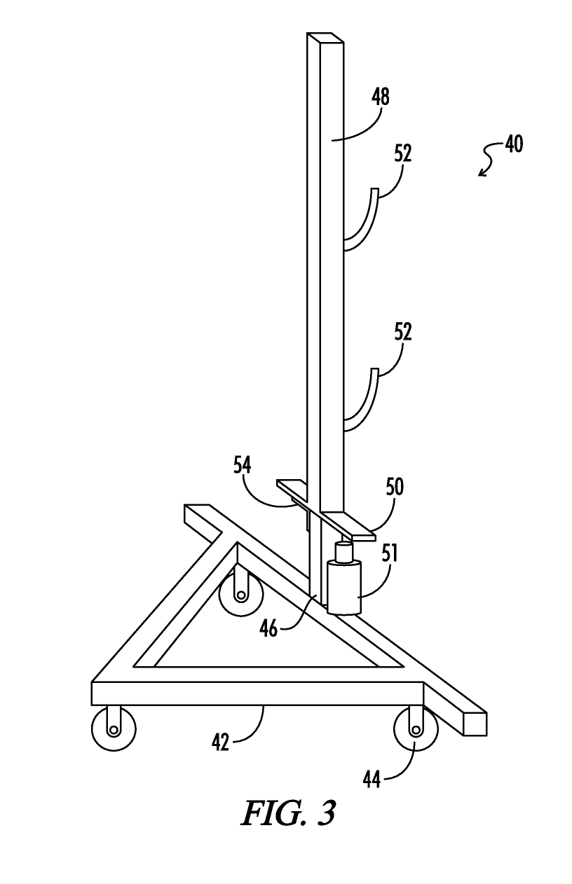

FIG. 3 depicts an exemplary embodiment of a positioning apparatus 40. The positioning apparatus 40 includes a triangular base 42 with a caster 44 affixed to the underside of each corner of the triangular base 42, such that the positioning apparatus 40 may be pivoted and rolled in any direction along a surface. In certain embodiments, the triangular base 42 is composed of tubes. In other embodiments, the triangular base 42 is composed of solid beams. The casters 44 are configured to allow the positioning apparatus 40 to roll along a surface. A support post 46 is affixed to the top of, and centrally located along, one side of the triangular base 42. In certain embodiments, the edge of the triangular base 42 to which the support post 46 is affixed is elongated relative to the other edges of the triangular base 42, as shown in FIG. 3.

In certain embodiments, the support post 46 is composed of a tube. In other embodiments, the support post 46 is composed of a solid beam. In certain embodiments, the support post 46 includes a bracket 54 affixed to the exterior surface of the support post 46. The bracket 54 may be affixed at different locations along the exterior surface of the support post 46. The bracket 54 may be composed of materials including, but not limited to, alloys and composites. The support post 46 is configured to fit within the inner periphery of a positioning post 48. The positioning post 48 is a tube configured to insert over the support post 46. In certain embodiments, the positioning post 48 rests on top of the bracket 54.

A crossbeam 50 is located at the base of the positioning post 48 and extends out from opposing faces of the positioning post 48. In certain embodiments, the crossbeam 50 is flattened with its faces on the top and bottom. The positioning post 48 further includes at least one positioning hook 52 located on the lateral surface distal to the triangular base 42. The positioning hook 52 is a hook configured to mount a wall panel 1 by insertion of the positioning hook 52 into a positioning aperture 5 on the wall panel 1. In certain embodiments, the positioning post 48 includes multiple positioning hooks 52 aligned vertically. The positioning hooks 52 may be uniformly or differentially spaced. Each positioning hook 52 is angled vertically away from the crossbeam 50.

In certain embodiments, in lieu of positioning hooks 52 the positioning post 48 includes at least one arm aperture 31 located on opposing faces and configured to accept the inserting of pins, bolts, clamps, and the like. The arm aperture 31 are positioned on opposing faces of the positioning post 48 by which a locking pin 26 may be used to connect to a positioning aperture 5 on each lateral edge 3 of the wall panel 1 to prevent the wall panel 1 from becoming dislodged from the positioning apparatus 40 while positioning the wall panel 1. In certain embodiments, the positioning post 48 includes multiple arm apertures 31 aligned vertically. The arm apertures 31 may be uniformly or differentially spaced.

The positioning post 48 is configured to raise and lower through the application and removal of force, respectively, to the underside of the crossbeam 50. The source of the force may include, but is not limited to, a jack 51 or other source of force known in the art.

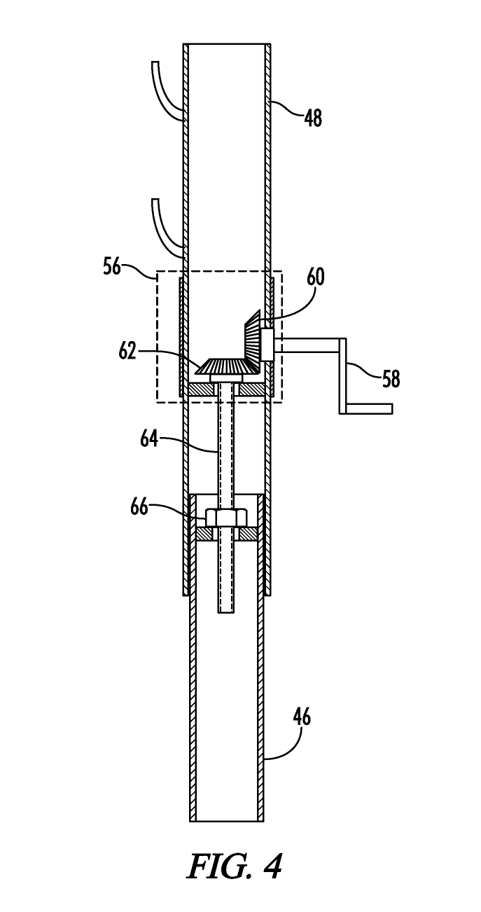

In other embodiments, in lieu of a jack 51, crossbeam 50, and bracket 54, the positioning post 48 may include a gearbox 56 located on the positioning post 48 configured to allow vertical adjustment of the positioning post 48, as shown in FIG. 4. The gearbox 56 includes an external adjustment handle 58 connected to a vertical spider gear 60 and horizontal spider 62 within the gearbox 56. The horizontal spider gear 62 is attached to an elongated threaded bolt 64 which is engaged by a nut 66 attached to the support post 46. The gearbox 56 is configured such that turning the adjustment handle 58 will cause the threaded bolt to thread into or out of the nut 66, depending on the direction the handle is turned, thereby raising or lowering the positioning post 48. In certain embodiments, the gearbox 56 may be located on the support 46 and the nut 66 on the positioning post 48.

In certain embodiments, the positioning apparatus 40 is composed of an alloy. In other embodiments, the positioning apparatus 40 is composed of a composite.

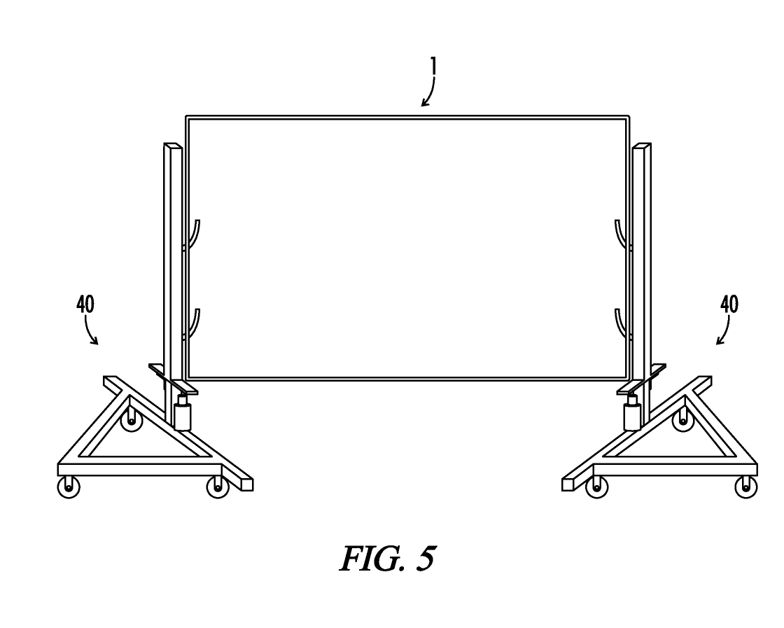

FIG. 5 depicts a first and second positioning apparatus 40 affixed to opposing edges of a wall panel 1. At least one positioning hook 52 on each positioning apparatus 40 fits into a positioning aperture 5 on the lateral edge 3 of the wall panel 1. Each positioning hook 52 is configured to support the wall panel 1. The wall panel 1 may be maneuvered and positioned by rolling the positioning apparatuses 40 along a surface. The wall panel 1 may be raised and lowered by adjusting the application of force, supplied by a source of force, to the crossbeam 50. The positioning apparatuses 40 are configured to allow the wall panel 1 to be directly lowered onto or into a surface. For example, if a channel has been created in a surface into which the wall panel 1 may fit, the positioning posts 48 of the positioning apparatuses 40 may be lowered by adjusting (reducing) the force applied to the crossbeam 50 of each positioning post 48.

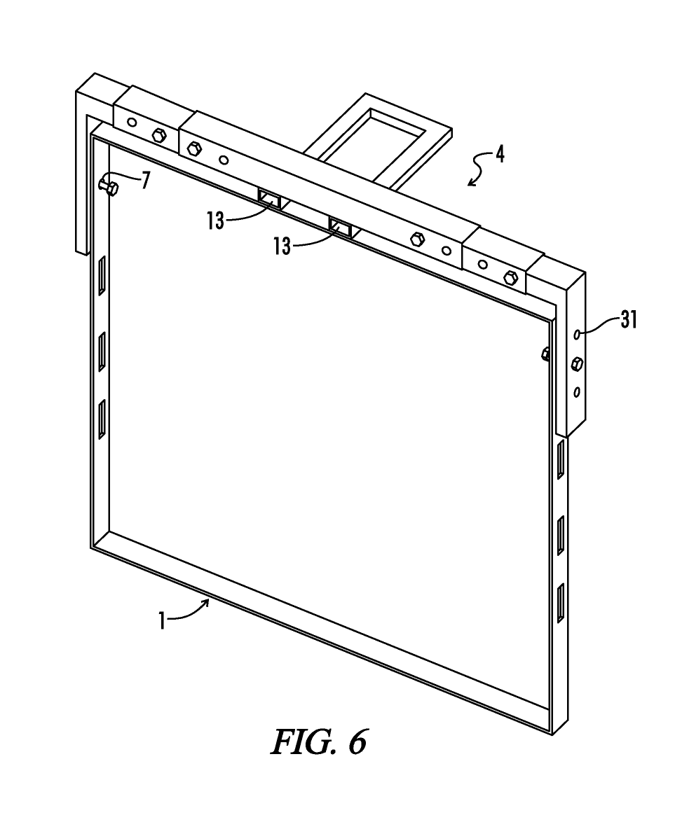

FIG. 6 depicts an exemplary embodiment of a lifting apparatus 11 lifted by a forklift and affixed to opposing edges of a wall panel 1. The forklift's tangs may be inserted into the tang receptacles 13 of the lifting apparatus 11. The lifting apparatus 11 may be further connected to the forklift by connecting a safety chain, secured to the forklift, around the crossmember 15 of the lifting apparatus 11. The forklift may be used to hold, raise, lower, and move the wall panel 1 by the lifting apparatus 11 connected to both the wall panel 1 and the forklift.

Each vertical arm 29 of each L-shaped lifting arm 21 includes at least one arm aperture 31 on opposing faces of the vertical arm 29 by which a locking pin 26 may be used to connect to a lifting aperture 7 on each lateral edge 3 of the wall panel 1 to prevent the wall panel 1 from becoming dislodged from the lifting apparatus 11 while lifting the wall panel 1.

A wall panel 1 may be lifted and moved using a forklift and lifting apparatus 11 and then transferred to two positioning apparatuses 40. To transfer the wall panel 1 from a lifting apparatus 11 to two positioning apparatuses 40, the positioning apparatuses 40 may be placed on opposing lateral edges 3 of the wall panel 1 while such wall panel 1 is supported by the lifting apparatus 11. Positioning hooks 52 on the positioning post 48 of each positioning apparatus 40 may be inserted into the positioning apertures 5 on the wall panel 1. If necessary, the height of the positioning posts 48 may be adjusted by adjusting the application of force, supplied by a source of force, to the crossbeams 50. Once the positioning apparatuses 40 are secured to the wall panel 1, the lifting apparatus 11 may be disconnected from the wall panel 1 by removing the bolt, pin, clamp, or like locking mechanism from all lifting apertures 7 on the wall panel 1.

In certain embodiments, the present disclosure contemplates a method of lifting a wall panel 1 using a lifting apparatus 11 by: inserting the tangs of a forklift into tang receptacles 13 of the lifting apparatus 11; securing a wall panel 1 to the lifting apparatus 11 by inserting locking pins 26 through the arm apertures 31 of the lifting apparatus 11 and into the lifting apertures 7 of the wall panel 1; and moving the wall panel 1 by operation of the forklift. For example, by raising the tangs of the forklift, the wall panel 1 will also raise. Similarly, the forklift may be driven to move the wall panel 1, attached to the forklift, to a desired location. In certain embodiments, the lifting apparatus 11 is secured to the forklift by attaching a safety chain from the frame of the forklift to the lifting apparatus 11, such as around the crossmember 15.

In certain embodiments, the present disclosure contemplates a method of positioning a wall panel 1 using a positioning apparatus 40 by: securing the positioning post 48 of a positioning apparatus 40 to each lateral edge 3 of a wall panel 1; rolling the positioning apparatuses 40—and thereby the wall panel 1—along a surface to a desired location; and removing the wall panel 1 from the positioning apparatus 40. In certain embodiments, a jack 51 is used to apply force to the brackets 54 to adjust the height of the positioning posts 48 to align the positioning hooks 52 with the positioning apertures 5 on the wall panel 1. In certain embodiments, the wall panel 1 is attached to a lifting apparatus 11 while the positioning posts are secured to the wall panel 1. In certain embodiments, force applied to the brackets 54 by a jack 51 is reduced to lower the wall panel 1—attached to the positioning posts 48—onto a surface.

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth.

The compositions, concentrations, and vehicles of the various embodiments described herein are exemplary. Various other compositions, concentrations, and vehicles for the formulations described herein are possible.

Now, therefore, the following is claimed:

1. A wall panel transport system comprising:
a panel-lifting member including,
a central support bar,
a pair of beams coupled to a central portion of the central support bar, each beam of the pair of beams including a tang-receiving channel configured for receiving a fork-lift tang, and
a substantially L-shaped lifting arm telescopically coupled to each end of the central support bar, and
a pair of panel-positioning members, each panel-positioning member including,
a wheeled base member,
a vertically-arranged telescoping-post supported by the wheeled base member, and
one or more support pins extending outwardly from the vertically-arranged telescoping-post.

2. The system of claim 1 wherein each substantially L-shaped lifting arm includes a first arm slidably coupled to the central support bar and a second arm, the second arm including a lifting pin extending therefrom and towards the other substantially L-shaped lifting arm.

3. The system according to claim 2 wherein the lifting pin is selectively removable from an opening in the second arm.

4. The system according to claim 1 wherein the beams of the pair of beams are arranged parallel to one another and perpendicular to the central support bar.

5. The system according to claim 1 wherein the wheeled base member includes three frame members arranged to form a triangle having three corners, each of the corners being coupled to a wheel.

6. The system according to claim 1 wherein the panel-positioning member includes jack member operatively coupled to the vertically-arranged telescoping-post, the jack member being selected from the group consisting a manually-powered jack and a hydraulically-powered jack.

7. The system according to claim 6 wherein the jack member extends to and between the wheeled base member and a jack-seat portion of the vertically-arranged telescoping-post.

8. The system according to claim 2 further comprising a wall panel configured for being lifted by the panel-lifting member and positioned by the pair of panel-positioning members, the wall panel including opposing lateral sides, each opposing lateral side of the opposing lateral sides including an upper opening configured for receiving the lifting pin and one or more lower openings configured for receiving the one or more support pins.

9. The system according to claim 8 wherein, for each opposing lateral side, the lifting pin extends through the upper opening and the one or more support pins extend, respectively, through the one or more lower openings.

10. A method of moving a wall panel with the system of claim 1, the method including securing a wall panel to and between the substantially L-shaped lifting arms, followed by lifting the wall panel with the panel-lifting member, followed by lowering the wall panel between the pair of panel-positioning members and securing the wall panel to the vertically-arranged telescoping-post of each panel-positioning member, followed by releasing the wall panel from the substantially L-shaped lifting arms, followed by rolling the wall panel across a floor using the pair of panel-positioning members.

11. The method according to claim 10 further comprising lifting the wall panel using the jack member of at least one of the pair of panel-positioning members.

12. A wall panel transport system comprising:
a panel-lifting member including,
a central support bar,
a pair of beams coupled to a central portion of the central support bar, each beam of the pair of beams including a tang-receiving channel, and
a substantially L-shaped lifting arm telescopically coupled to each end of the central support bar.

13. The system of claim 12 wherein each substantially L-shaped lifting arm includes a first arm slidably coupled to the central support bar and a second arm, the second arm including a lifting pin extending therefrom and towards the other substantially L-shaped lifting arm.

14. The system according to claim 1 wherein the beams of the pair of beams are arranged parallel to one another and perpendicular to the central support bar.

15. The system according to claim 13 further comprising a wall panel configured for being lifted by the panel-lifting member, the wall panel including opposing lateral sides, each opposing lateral side of the opposing lateral sides including an upper opening configured for receiving the lifting pin.

16. The system according to claim 12 further comprising a pair of panel-positioning members, each panel-positioning member including a wheeled base member, a vertically-arranged telescoping-post supported by the wheeled base member, and one or more support pins extending outwardly from the vertically-arranged telescoping-post.

17. A method of moving a wall panel with the system of claim 16, the method including securing a wall panel to and between the substantially L-shaped lifting arms, followed by lifting the wall panel with the panel-lifting member, followed by lowering the wall panel between the pair of panel-positioning members and securing the wall panel to the pair of panel-positioning members, followed by releasing the wall panel from the substantially L-shaped lifting arms.

18. A wall panel transport system comprising:
a pair of panel-positioning members, each panel-positioning member including,
a wheeled base member,
a vertically-arranged telescoping-post supported by the wheeled base member, and
one or more support pins extending outwardly from the vertically-arranged telescoping-post.

19. The system according to claim 18 further comprising a panel-lifting member having a pair of tang-receiving channels configured for receiving a fork-lift tang.

20. The system according to claim 19 further comprising a wall panel configured for being lifted by the panel-lifting member and positioned by the pair of panel-positioning members, the wall panel including opposing lateral sides, each opposing lateral side of the opposing lateral sides including an upper opening and one or more lower openings configured for receiving the one or more support pins.

21. A method of moving a wall panel with the system of claim 19, the method including securing a wall panel to the panel lifting member, followed by lifting the wall panel with the panel-lifting member, followed by lowering the wall panel between the pair of panel-positioning members and securing the wall panel to the vertically-arranged telescoping-post of each panel-positioning member, followed by rolling the wall panel across a floor using the pair of panel-positioning members.
